(19) United States
(12) Patent Application Publication
(10) Pub. No.: US 2012/0181888 A1
(43) Pub. Date: Jul. 19, 2012

(54) ROTARY ELECTRIC MACHINE ROTOR

(75) Inventors: Yuichi Shibukawa, Yokohama-shi (JP); Robert Donald Lorenz, Madison, WI (US); Natee Limsuwan, Madison, WI (US)

(73) Assignees: WISCONSIN ALUMNI RESEARCH FOUNDATION, Madison, WI (US); NISSAN MOTOR CO., LTD., Yokohama, Kanagawa (JP)

(21) Appl. No.: 13/497,199

(22) PCT Filed: Sep. 10, 2010
(86) PCT No.: PCT/IB2010/002250

§ 371 Date: Mar. 20, 2012

(51) Int. Cl. H02K 21/12

(52) U.S. Cl. 310/156.01

(57) ABSTRACT

A rotary electric machine rotor is provided with a rotor shaft, a rotor core, and a group of permanent magnets. The rotor core includes a group of flux barriers arranged at intervals. At least one of the flux barriers includes at least one bridge joining an inner edge and an outer edge of that flux barriers. The permanent magnets are arranged at the rotor core between the flux barriers as viewed in the cross sectional plane.

### BACKGROUND

1. Field of the Invention

The present invention generally relates to a rotor for use in a rotary electric machine. More particularly, the present invention relates to a rotor that includes magnetic flux barriers configured to reduce or eliminate damage to the rotor core while improving rotational position sensing and output torque.

2. Background Information

In order to reduce manufacturing cost and decrease unit size of an IPM (interior permanent magnet) type rotary electric machine, sensor-less technology is being developed in which a sensor for detecting a rotational position of the rotor can be omitted. As understood in the art, a sensor-less rotor is generally referred to as a self-sensing type rotor whose rotational position can be sensed without the use of an external sensor or a sensor added to the rotor.

When a rotor rotates at a high speed, a large induced voltage occurs. A position of a permanent magnet on the rotor can be estimated based on a waveform of the induced voltage. This estimated position of the permanent magnet is thus used to estimate a rotational position of the rotor. However, if the rotor rotates slowly, the induced voltage is small. Consequently, if the rotor is stopped or rotating extremely slowly, then the position of the permanent magnet generally cannot be accurately estimated based on a waveform of an induced voltage.

Therefore, techniques are being developed in which a position of the rotor is estimated based on a measured electric current value, and a result obtained by overlapping a higher frequency onto a base voltage waveform that forms a rotational magnetic field around the rotor to create a rotary torque for the rotor. More specifically, as with air, the magnetic permeability of a permanent magnet is small, and magnetic flux does not readily flow in a permanent magnet. However, the magnetic permeability of electromagnetic steel plates, such as those used in the rotor, is large. Therefore, when electromagnetic steel plates are disposed between permanent magnets magnetic flux flows readily in the electromagnetic steel plates. The ease at which the magnetic flux can flow is expressed as inductance. Therefore, by applying a high frequency voltage signal to a stator coil to generate a magnetic field that rotates faster than the rotor, a position of the rotor can be estimated based on the contrast between locations on the rotor where the magnetic flux flows readily and locations on the rotor where the magnetic flux does not flow readily. In this way, the position of the rotor can be estimated even when the rotor is stopped or rotating at an extremely low speed.

Japanese Laid-Open Patent Publication No. 2008-295138 discloses an example of an IPM rotary electric machine. In that machine, a flux barrier is provided to cause a q-axis inductance Lq to be larger than a d-axis inductance Ld.

### SUMMARY

However, it has been discovered that in this type of IPM rotary electric machine, during high-speed rotation a large centrifugal force acts on a portion of the rotor core that is located in a radial direction farther outward than the flux barrier. Consequently, it is necessary for the structure of the flux barrier to withstand the centrifugal force to avoid damage, such as deformation, to that portion of the rotor core. In particular, the thickness between the flux barrier and a surface of the rotor core (which can also be referred to as the steel bridge close to the surface of the rotor core that holds the laminated layers of the rotor core together) is made large enough to have sufficient structure to withstand the centrifugal force. However, this structure allows magnetic flux to easily leak from that portion of the rotor core, especially when the rotor is under a high load. Furthermore, when the magnetic flux generated by a rotating magnetic field of the stator coil is applied, the magnetic flux density of the q-axis becomes large. As a result, the d-axis inductance is also affected such that an asymmetrical magnetic flux distribution is generated on opposite sides of the d-axis. When this occurs, the estimated positions of the d-axis and the q-axis are offset from their actual positions. Therefore, the accuracy at which the rotational position of the rotor can be estimated is less reliable.

The rotor of the present disclosure was developed in view of this problem and other problems associated with an IPM type rotor. Accordingly, one object is to provide a rotary electric machine rotor whose rotational position can be estimated accurately by self-sensing or sensor-less control that omits the use of a sensor. Examples of rotors that are capable of achieving the aforementioned object are described herein.

In view of the state of the known technology, one aspect of the present disclosure is to provide a rotary electric machine rotor that basically comprises a rotor shaft, a rotor core and a group of permanent magnets. The rotor core includes a group of flux barriers. The flux barriers are arranged at intervals. At least one of the flux barriers includes at least one bridge joining an inner edge and an outer edge of that flux barrier. The permanent magnets are arranged at the rotor core between the flux barriers as viewed in the cross sectional plane.

### BRIEF DESCRIPTION OF THE DRAWINGS

Referring now to the attached drawings which form a part of this original disclosure:

FIG. 1A is a partial transverse cross sectional view of a portion of a rotary electric machine rotor in accordance with a first embodiment, with the cross section taken along a section line that lies in a plane perpendicular to an axis of rotation of a rotor shaft and that shows ⅓ (120 degrees) of the entire circumference of the rotor;

FIG. 1B is an enlarged section of a portion of the rotary electric machine rotor illustrated in FIG. 1A;

FIG. 2 is a full transverse cross sectional view including the portion of the rotary electric machine rotor illustrated in FIG. 1 for illustrating an operational effect of the first embodiment;

FIG. 3A is a partial transverse cross sectional view of a portion of a rotary electric machine rotor in accordance with a second embodiment, with the cross section taken along a section line that lies in a plane perpendicular to an axis of rotation of a rotor shaft and that shows ⅓ (120 degrees) of the entire circumference of the rotor;

FIG. 3B is an enlarged section of a portion of the rotary electric machine rotor illustrated in FIG. 3A;

FIG. 4A is a partial transverse cross sectional view of the portion of the rotary electric machine rotor illustrated in FIG. 3 for illustrating an operational effect of the second embodiment;

FIG. 4B is an enlarged section of a portion of the rotary electric machine rotor illustrated in FIG. 4A in a no load situation;

FIG. 4C is an enlarged section of a portion of the rotary electric machine rotor illustrated in FIG. 4A in a load situation;

FIG. 5 is a partial transverse cross sectional of a rotary electric machine rotor in accordance with a third embodiment, with the cross section taken along a section line that lies in a plane perpendicular to an axis of rotation of a rotor shaft and that shows ⅓ (120 degrees) of the entire circumference of the rotor;

FIG. 6A is a partial transverse cross sectional view of a portion of a rotary electric machine rotor in accordance with a fourth embodiment, with the cross section taken along a section line that lies in a plane perpendicular to an axis of rotation of a rotor shaft and that shows ⅓ (120 degrees) of the entire circumference of the rotor;

FIG. 6B is an enlarged section of a portion of the rotary electric machine rotor illustrated in FIG. 6A;

FIG. 7A is a partial transverse cross sectional view of a portion of a rotary electric machine rotor in accordance with a fifth embodiment, with the cross section taken along a section line that lies in a plane perpendicular to an axis of rotation of a rotor shaft and that shows ⅓ (120 degrees) of the entire circumference of the rotor;

FIG. 7B is an enlarged section of a portion of the rotary electric machine rotor illustrated in FIG. 7A; and

FIG. 8 is a plot comparing the results obtained with the rotary electric machine rotors of the second to fifth embodiments.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

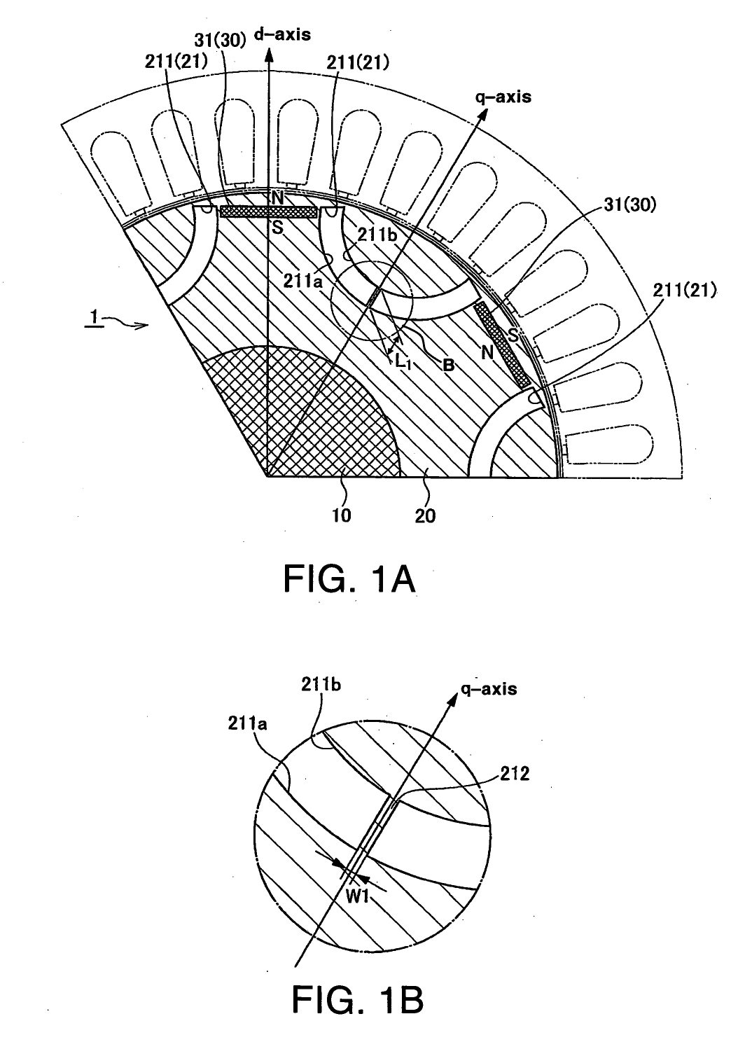

Referring initially to FIG. 1A, a partial transverse cross sectional view of a portion of a rotary electric machine rotor is illustrated in accordance with a first embodiment, with the cross section taken along a section line that lies in a plane perpendicular to an axis of a rotor shaft and that shows ⅓ (120 degrees) of the entire circumference of the rotor.

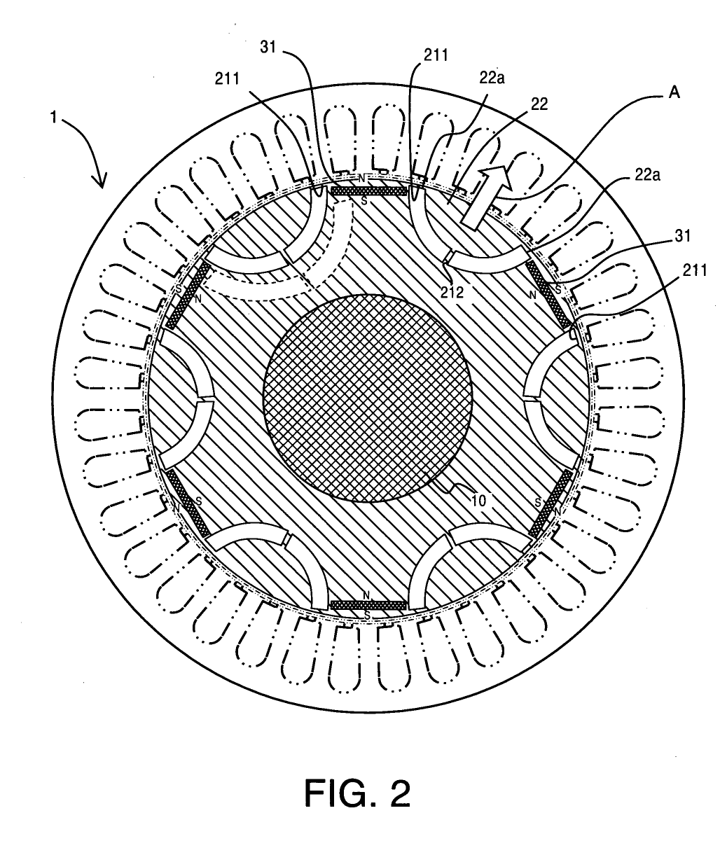

FIG. 1B is an enlarged view of a portion B of FIG. 1A, and FIG. 2 is a full cross sectional view including the portion shown in FIG. 1A. The rotary electric machine rotor 1 in this example has a rotor shaft 10, a rotor core 20, and a group 30 of permanent magnets 31. The rotor shaft 10 is a rotary shaft of the rotor 1. The rotor core 20 is provided on a periphery of the rotor shaft 10. The exemplary rotor core 20 includes a plurality of electromagnetic steel plates layered along an axial direction of the rotor shaft 10. The rotor core 20 also includes a group 21 of flux barriers 211. The flux barriers 211 are portions having a magnetic permeability lower than that in the electromagnetic steel plate portions of the rotor core 20. Thus, it is difficult for magnetic flux to pass through the flux barriers 211.

As shown in FIG. 1A, the flux barriers 211 are arranged at fixed mechanical angle intervals such that they protrude toward the rotor shaft 10. In this embodiment, the flux barriers 211 are air layers. The flux barriers 211 are arranged at or about 60-degree mechanical angle intervals and shaped like circular arcs arranged to extend toward the rotor shaft 10. That is, the arcuate portion of each flux barrier 211 is proximate to the shaft, and the ends of each flux barrier 211 are proximate to the outer surface of the rotor core 20. In this embodiment, the flux barrier group 21 includes six flux barriers 211 arranged around the full circumference of the rotor core 20. As shown in the enlarged view of FIG. 1B, the flux barriers 211 each includes a bridge 212 that joins an inner edge 211a and an outer edge 211b of the flux barrier 211. The bridge 212 having a length L1 and a width W1 is formed along a q-axis that is electrically orthogonal to a d-axis coinciding with a magnetic pole center axis of a permanent magnet 31 as discussed in more detail below. The length L1 can be 4.4 mm or approximately 4.4 mm, or any other suitable length, and the width W1 can be 0.5 mm or about 0.5 mm, or any other suitable length (e.g., as determined from the feasibility of the fabrication process of the rotor core 20). The flux barriers 211 together constitute the flux barrier group 21.

The permanent magnet group 30 is provided in the rotor core 20. As shown in FIGS. 1A and 2, the permanent magnet group 30 is a group of permanent magnets 31 arranged between the flux barriers 211 of the flux barrier group 21. In this embodiment, the permanent magnet group 30 includes six permanent magnets 31 arranged around the full circumference of the rotor core 20. The permanent magnets 31 are arranged such that adjacent permanent magnets 31 have alternately different polarities. In FIG. 1A, the left-hand permanent magnet 31 that is intersected by the d-axis is arranged such that its N-pole is positioned radially outward and its S-pole is positioned radially inward. Alternatively, the permanent magnet 31 on the right-hand of FIG. 1A is arranged such that its S-pole is positioned radially outward and its N-pole is positioned radially inward. Naturally, the poles of these permanent magnets 31 can be reversed. Also, one or more of the flux barriers 211 can be arranged with their ends extending toward the magnets 31 as shown in phantom in FIG. 2 and discussed below.

FIG. 2 further illustrates an example of an operational effect that occurs in the rotary electric machine rotor 1 according to the first embodiment. When the rotary electric machine rotor 1 rotates, a centrifugal force indicated by an arrow A acts on a portion 22 of the rotor core 20 that is positioned farther outward radially than the flux barriers 211. If the bridge 212 of this embodiment was not provided, then the left and right end portions 22a of the rotor portion 22 would need to be thicker in order to withstand the centrifugal force to prevent the centrifugal force from deforming the rotor core portion 22. However, increasing the thickness would make it easier for magnetic flux of the permanent magnets 31 to leak from the end portions 22a. Consequently, a left-right asymmetrical magnetic flux density distribution would develop on opposite sides of the d-axis. As a result, the estimated positions of the d-axis and the q-axis would be offset from their actual positions, and the accuracy at which the rotational position of the rotor 1 could be estimated would be diminished.

However, since the flux barriers 211 have bridges 212, the left and right end portions 22a of the rotor core portions 22 can be made narrower. That is, the width W1 of a bridge 212 is smaller than the amount of thickness removed from the left and right end portions 22a of the rotor core portion 22 in order to provide the bridge 212. Consequently, magnetic flux leaks less readily when the bridge 212 is formed than when the left and right end portions 22a of the rotor core portion 22 are made thicker. As a result, a magnetic flux density that is left-right symmetrical on opposite sides of the d-axis is fowled, and the rotational position of the rotor can thus be estimated with improved accuracy.

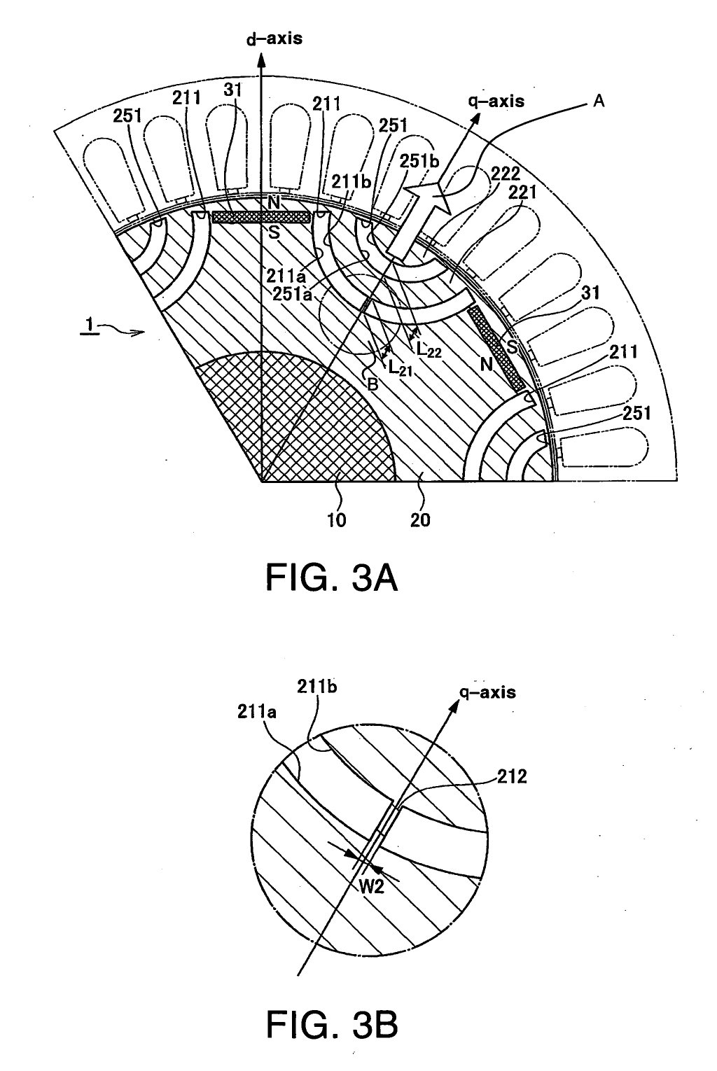

FIGS. 3A and 3B show a rotary electric machine rotor according to a second embodiment. FIG. 3A is a cross sectional view in a plane perpendicular to an axis of rotation of the rotor shaft 10 and shows ⅓ (120 degrees by mechanical angle) of the entire circumference of the rotor. FIG. 3B is an enlarged view of a portion B of FIG. 3A. The rotor core 20 of this embodiment further includes a group 25 of at least one flux barrier 251 positioned radially outward of the flux barriers 211. In this embodiment, a width of a flux barrier 211 in a radial direction of the rotor 1, that corresponds to the length L21 of the bridge 212 as shown, is smaller than a width of a flux barrier 211 in a radial direction of the rotor 1 in the first embodiment, that corresponds to the length L1 of the bridge 212 in that first embodiment. The length L21 can be 3.1 mm or approximately 3.1 mm, or any other suitable length. These widths of the flux barriers 211 and 251 can also thus be referred to as the radial lengths. In this example, the sum of the radial length L21 of the flux barrier 211 and the radial length L22 of the flux barrier 251 (which can be 2.56 mm or approximately 2.56 mm) is equal to or substantially equal to the radial length L1 of the flux barrier 211 in the first embodiment. Furthermore, in this example, the flux barrier 251 is not provided with a bridge extending between the inner edge 251a and the outer edge 251b. Specifically, none of the flux barriers 251 in the group 25 includes a bridge. Also, as shown in FIG. 3B, a width W2 of the bridge 212 can be 0.5 mm or approximately 0.5 mm, or can be smaller than the width W1 of the bridge 212 in the first embodiment, for reasons discussed below.

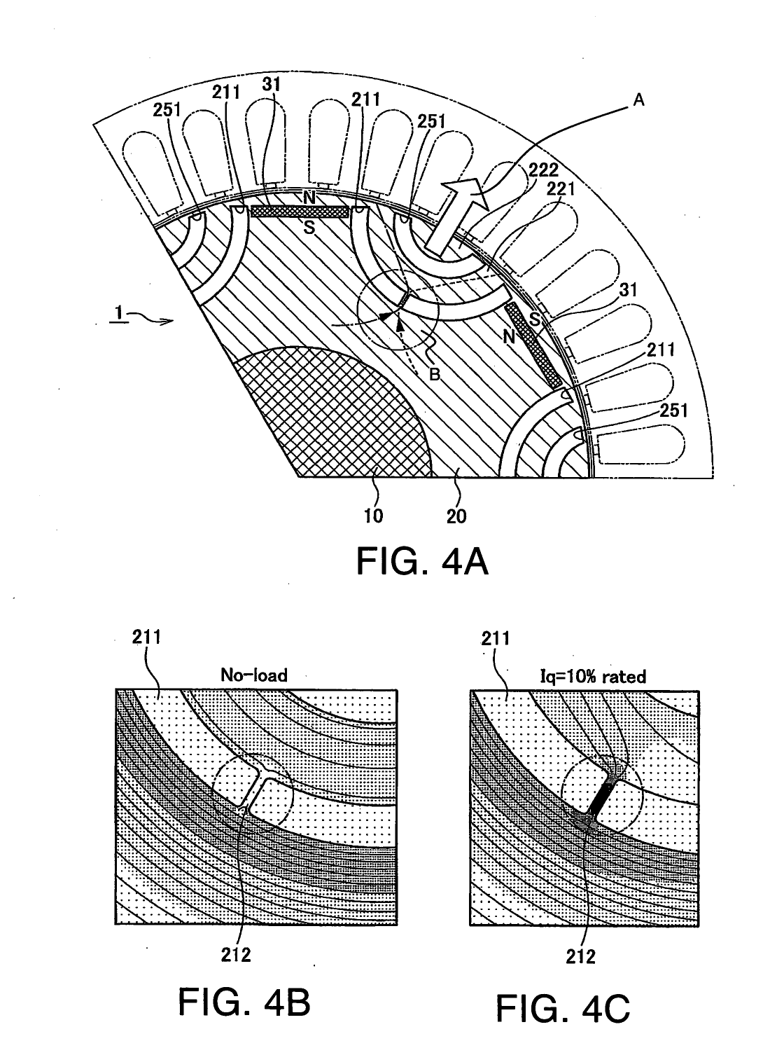

FIGS. 4A, 4B and 4C illustrate an example of an operational effect that occurs in the rotary electric machine rotor 1 according to the second embodiment. FIG. 4A is a cross sectional view in a plane perpendicular to an axis of rotation of rotor shaft 10 and shows ⅓ (120 degrees by mechanical angle) of the entire circumference of the rotor 1. FIG. 4B illustrates a magnetic flux analysis of a portion B when a magnetic flux caused by a rotating magnetic field of the stator coil is not flowing, and FIG. 4C illustrates a magnetic flux analysis of a portion B when a magnetic flux caused by a rotating magnetic field of the stator coil is flowing, as indicated by the broken lines in FIG. 4A. In this embodiment, a portion radially outward from the flux barriers 211 is divided into an inner portion 221 that is positioned radially inward of the flux barriers 251, and an outer portion 222 that is positioned radially outward of the flux barriers 251. The inner portion 221 is smaller than the rotor core portion 22 of the first embodiment. Thus, when the rotary electric machine rotor 1 rotates, the centrifugal force acting on the inner portion 221 is smaller than the centrifugal force that acts on the rotor core portion 22 of the first embodiment. Consequently, the width W2 of the bridge 212 can be made narrower than the width W1 of the bridge 212 in the first embodiment.

When a magnetic flux caused by a rotating magnetic field of the stator coil is not flowing in the bridge 212, the state is as shown in FIG. 4B. However, when a magnetic flux caused by a rotating magnetic field of the stator coil is flowing in the bridge 212, the state is as shown in FIG. 4C. FIG. 4C indicates degrees of magnetic saturation with light and dark shading. As indicated, the bridge 212 is shaded darkly, indicating that the bridge 212 is magnetically saturated. The bridge 212 becomes magnetically saturated when even a small load is present, and the amount of magnetic flux passing through the bridge 212 does not increase once the bridge 212 is saturated.

In this embodiment, as explained previously, the width W2 of the bridge 212 is smaller than the width W1 of the bridge 212 in the first embodiment. Thus, the bridge 212 becomes saturated and does not allow magnetic flux to flow at a smaller load than in the first embodiment. Consequently, this arrangement prevents magnetic flux from leaking even more effectively than the first embodiment. Thus, the rotational position of the rotor 1 is estimated with improved accuracy. It should also be noted that as with the second embodiment the flux barrier 251 is not provided with a bridge extending between the inner edge 251a and the outer edge 251b. Specifically, none of the flux barriers 251 in the group 25 includes a bridge. If a bridge is present in a flux barrier 251, then there is a possibility that a magnetic flux caused by a rotating magnetic field of the stator coil would leak from that bridge. Furthermore, the centrifugal force acting on the outer portion 222 located radially outward from the flux barrier 251 is generally small because the outer portion 222 is small. As a result, the flux barriers 251 can withstand the centrifugal force without a bridge being present in the flux barriers 251.

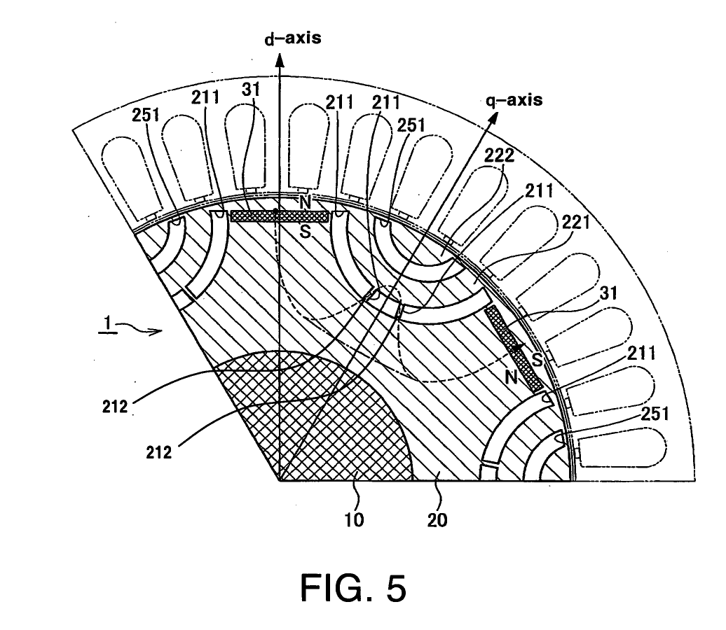

FIG. 5 is a cross sectional view of a rotary electric machine rotor 1 according to a third embodiment. As with the first and second embodiments, the cross section lies in a plane perpendicular to an axis of rotation of the rotor shaft 10 and shows ⅓ (120 degrees by mechanical angle) of the entire circumference of the rotor 1. In this embodiment, when viewed in a cross section perpendicular to the rotor shaft 10, two bridges 212 are formed in each flux barrier 211 in the rotor core 20. The flux bridges 212 are formed to be left-right symmetrical or substantially symmetrical on opposite sides of a q-axis that is electrically orthogonal to a d-axis coinciding with a magnetic pole center axis of a permanent magnet 31.

When two bridges 212 are formed in this manner, the width of each bridge 212 is smaller than the width of the bridge 212 in the second embodiment. The permanent magnets 31 of the permanent magnet group 30 are arranged such that adjacent permanent magnets 31 have alternately different polarities as in the first and second embodiments. As indicated with broken line in FIG. 5, a portion of the magnetic flux of the permanent magnets 31 flows through the two bridges 212. The bridges 212 become magnetically saturated with magnetic flux from the permanent magnets 31 easily because they are narrow. Thus, the magnetic flux caused by a rotating magnetic field of the stator coil does not readily leak from the bridges 212. Consequently, this embodiment prevents magnetic flux from leaking even more effectively than the first and second embodiments. Accordingly, the rotational position of the rotor 1 can be estimated with further improved accuracy.

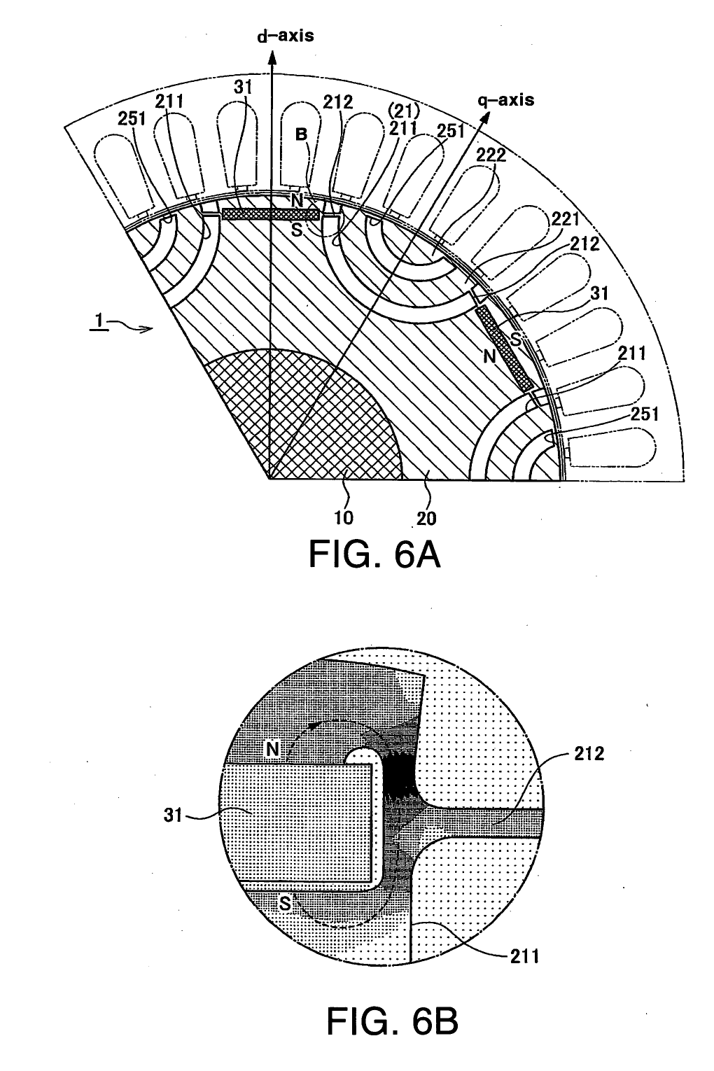

FIGS. 6A and 6B show a rotary electric machine rotor according to a fourth embodiment. FIG. 6A is a cross sectional view in a plane perpendicular to an axis of rotation of rotor shaft 10 and shows ⅓ (120 degrees by mechanical angle) of the entire circumference of the rotor 1. FIG. 6B illustrates a magnetic flux analysis of a portion B of FIG. 6A. In this embodiment, when viewed in a cross section perpendicular to the rotor shaft, two bridges 212 are formed in each flux barrier 211 of the rotor core 20 at positions adjacent to the permanent magnets 31. The two bridges 212 are also formed so as to be left-right symmetrical on opposite sides of a q-axis that is electrically orthogonal to a d-axis coinciding with a magnetic pole center axis of a permanent magnet 31.

As shown in FIG. 6B, magnetic flux of the permanent magnet 31 flows as indicated by the broken line through a region adjacent to the permanent magnet 31. Since the width of the electromagnetic steel plate is small between the permanent magnet 31 and the flux barrier 211, the region becomes magnetically saturated by the magnetic flux of the permanent magnet 31. Thus, providing the two bridges 212 in positions adjacent to the permanent magnets 31 makes it more difficult for magnetic flux caused by a rotating magnetic field of the stator coil to flow. Moreover, a distance between one of the flux barriers 211 and a respective one of the permanent magnets 31 to which the bridge 212 of that flux barrier 211 is adjacent is inversely proportional to a degree to which the bridge 212 of that flux barrier 211 become magnetically saturated by a magnetic flux provided by that permanent magnet 31 adjacent to that bridge 212. In other words, the bridge 212 is configured to become saturated by the magnetic flux from permanent magnet. Thus, if the bridge 212 is not saturated (saturation is low), this means that the distance between the flux barrier 211 and the magnet 31 is too large, and should be made smaller to increase the saturation. On the other hand, if the saturation in bridge 212 is already high, this means that the distance between the flux barrier 211 and the magnet 31 is already small enough. Therefore, the distance between the flux barrier 211 and the magnet 31 can remain as is, or the distance between flux barrier 211 and magnet 31 can be enlarged, as long as the saturation in bridge 212 remains sufficiently high.

Consequently, with the above arrangements, it is even more difficult for magnetic flux to leak from the bridges 212. Thus, the rotational position of the rotor 1 can be estimated with improved accuracy.

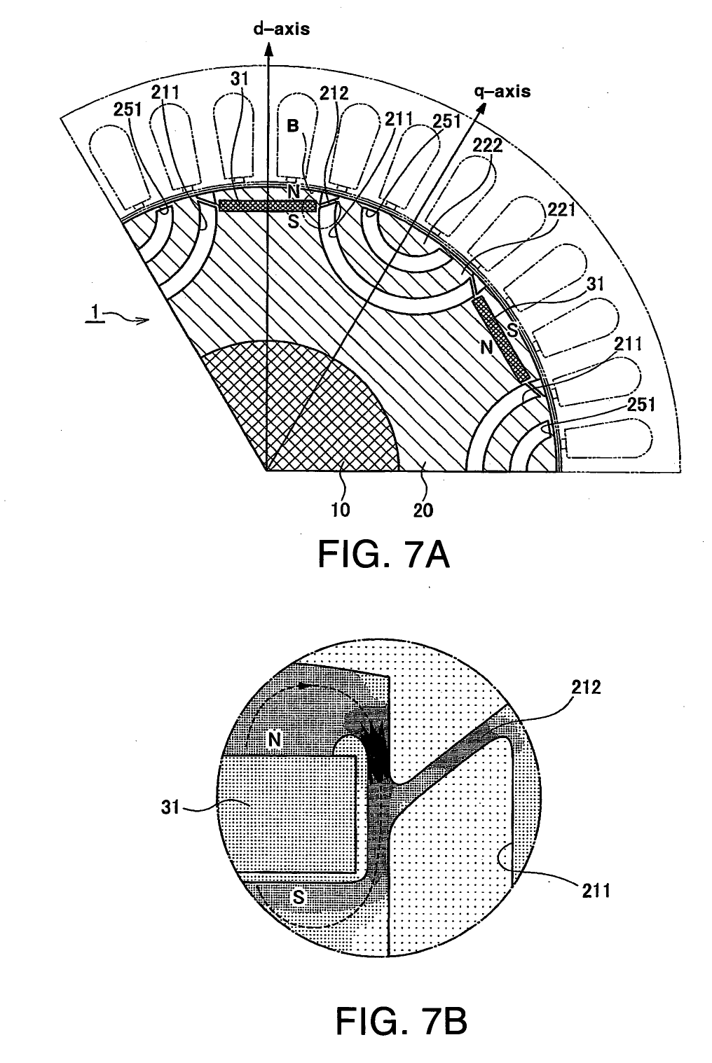

FIGS. 7A and 7B show a rotary electric machine rotor according to a fifth embodiment. FIG. 7A is a cross sectional view in a plane perpendicular to an axis of rotation of rotor shaft 10 and shows ⅓ (120 degrees by mechanical angle) of the entire circumference of the rotor. FIG. 7B illustrates a magnetic flux analysis of a portion B of FIG. 7A, with the flow of magnetic flux indicted by a broken line. In this embodiment, two bridges 212 are formed in each flux barrier 211 of the rotor core 20 at positions adjacent to the permanent magnets 31 so as to be left-right symmetrical with respect to a q-axis. Additionally, the bridges 212 are configured to extend diagonally in a direction away from the permanent magnets 31 such that they approach a radially outward surface of the rotor core 20 as they approach the other side of the flux barrier 211. In other words, the end of a bridge 212 proximate to a permanent magnet is further any from the radially outward surface of the rotor core 20 than is the opposite end of that bridge 212.

When the bridges 212 are configured to be diagonal in the manner of this embodiment, a bending moment caused by a centrifugal force acting on the inner portion 221 is suppressed, such that a resulting stress is reduced. As a result, the strength is increased. Thus, with this embodiment, the bridge 221 can be made narrower even than with the fourth embodiment. When this is done, it becomes more difficult for a magnetic flux caused by a rotating magnetic field of the stator coil to flow in the bridges 212 than in the fourth embodiment. Consequently, this embodiment prevents magnetic flux from leaking even more effectively than the previous embodiments. Accordingly, the accuracy with which the rotational position of the rotor is estimated can be further improved.

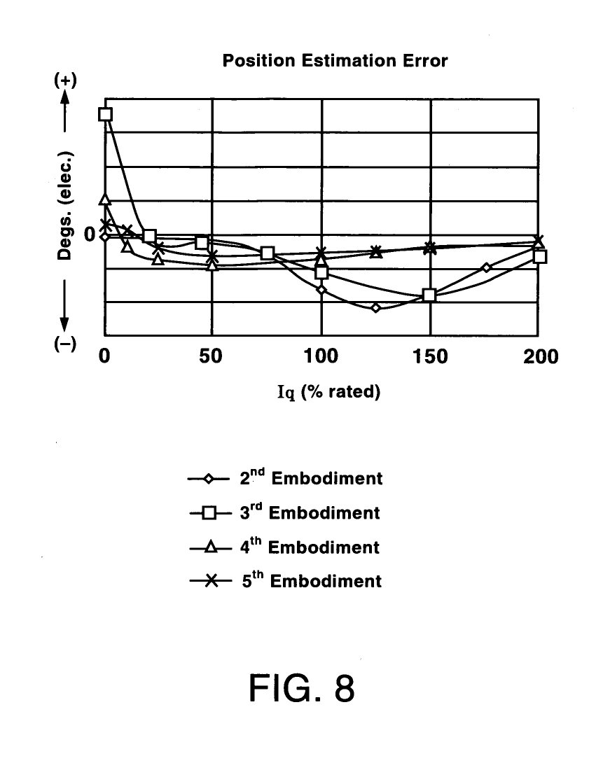

FIG. 8 compares exemplary results obtained with the second to fifth embodiments. In FIG. 8, the exemplary results obtained with the second embodiment are represented by diamonds, the exemplary results obtained with the third embodiment are represented by squares, the exemplary results obtained with the fourth embodiment are represented by triangles, and the exemplary results obtained with the fifth embodiment are represented by Xs. In FIG. 8, the horizontal axis indicates a load, and the vertical axis indicates an error of the estimated position (position estimation error). The error is indicated as a positive or negative error with respect to a reference error of zero. With the second embodiment, the position estimation error is small compared to a rotor 1 not provided with a bridge, and the rotational position of the rotor 1 is estimated with improved accuracy. With the third embodiment, the output torque is satisfactory but the position estimation error is larger in a low load region. With the fourth embodiment, the position estimation error is small even at low loads, and the rotational position of the rotor is estimated with improved accuracy across all load regions. With the fifth embodiment, the position estimation error is even smaller across all load regions, and the rotational position of the rotor is estimated with improved accuracy.

The present invention is not limited to the embodiments explained herein. Rather, it should be apparent to those skilled in the art that various variations and modifications can be made without departing from the technical scope of the invention. For example, in the embodiments, the flux barriers are air layers, but it is acceptable for the flux barriers to be spaces filled with a resin or other material having a smaller magnetic permeability than the electromagnetic steel plates used in the rotor core 20. Also, although in the second embodiment the group 25 of the flux barriers 251 is provided in positions radially outward of the group 21 of flux barriers 211, it is acceptable to provide still another group of flux barriers, or multiple additional groups of flux barriers. Furthermore, although a bridge is not provided joining an inner edge 251a and an outer edge 251b of the flux barriers 251 in, for example, the second embodiment, it is acceptable to provide such a bridge in any of the flux barriers in any of the embodiments. In addition, in the fifth embodiment, the bridges 212 are arranged such that they approach an outer surface as they extend away from the permanent magnets 31. However, it is also acceptable to arrange the bridges 212 to be angled in the opposite direction, such that the ends of the bridges 212 proximate to the permanent magnets 31 are closer to the outer surface of the rotor 1. The bridges can have other shapes, and can be positioned at other locations in the flux barriers, to affect flux leakage as desired.

For example, in the embodiments discussed above, the flux barriers (e.g., 21, 211, 251 discussed above) are arranged symmetrically around q-axis. It should also be noted that the flux barriers might be arranged symmetrically at a fixed angle around the center of the magnet (i.e., the d-axis), in which case the flux barriers are not arranged with a fixed mechanical angle in the rotor core 20. Also, the flux barriers do not necessarily have to protrude toward the rotor shaft 10, but can also protrude toward the outer surface of the rotor core 20. In other words, the rounded part of the flux barrier would be close to the outer surface of the rotor core 20 and the ends of the flux barrier would extend toward the rotor shaft 10. Of course, the flux barriers can be arranged and oriented in any suitable manner with respect to the rotor shaft 10 and outer surface of the rotor core 20. In addition, the flux barriers (e.g., 21, 211, 251 as discussed above) can be above or below the magnet as viewed in the cross sectional plane. The examples discussed above illustrate the flux barriers being above the magnet. However, one or more of the flux barriers can be configured so that each of the ends of the flux barrier is proximate to a respective magnet, and the arced portion of the flux barrier is proximate to the rotor shaft 10. In other words, referring to FIG. 1A, the end of the flux barrier having reference number 211 (21) pointing thereto would be positioned proximate to the S pole of the magnet intersected by the d-axis, and the opposite end of the flux barrier would be proximate to the N pole of the other magnet, with the arced portion of the flux barrier being proximate to the rotor shaft 10, as shown in phantom in FIG. 2. In this event, the bridge 212 is likely configured to have a larger W1 than in the embodiments in which the flux barrier is below the magnets. Naturally, as discussed above, at least some of the flux barriers in all configurations discussed above need not include a bridge.

In addition, the structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A rotary electric machine rotor comprising:
a rotor shaft;
a rotor core provided on the rotor shaft, the rotor core including a group of flux barriers with the flux barriers being arranged at intervals, and at least one of the flux barriers includes at least one bridge joining an inner edge and an outer edge thereof; and
a group of permanent magnets arranged at the rotor core between the flux barriers as viewed in the cross sectional plane.

2. The rotary electric machine rotor as recited in claim 1, wherein
the bridge has a width sufficient to withstand a centrifugal force acting on a rotor core portion located radially outward of the flux barriers to prevent deformation of the rotor core portion due to the centrifugal force.

3. The rotary electric machine rotor as recited in claim 1, wherein
the bridge is formed along a q-axis that is electrically orthogonal to a d-axis coinciding with a magnetic pole center axis of one of the permanent magnets as viewed in the cross sectional a plane.

4. The rotary electric machine rotor as recited in claim 1, wherein
two of the bridges are formed in at least one of the flux barriers so as to be symmetrically spaced on opposite sides of a q-axis that is electrically orthogonal to a d-axis coinciding with a magnetic pole center axis of one of the permanent magnets as viewed in the cross sectional plane.

5. The rotary electric machine rotor as recited in claim 4, wherein
each of the bridges is formed adjacent to a respective one of the permanent magnets; and
a distance between one of the flux barriers and a respective one of the permanent magnets is inversely proportional to a degree to which the bridges of that one of the flux barriers become magnetically saturated by a magnetic flux provided by the permanent magnets adjacent to the bridges of that one of the flux barriers.

6. The rotary electric machine rotor as recited in claim 5, wherein
the bridges are configured to approach the outer circumference of the rotor core as they extend away from their respective permanent magnets.

7. The rotary electric machine rotor as recited in claim 1, wherein
the rotor core is further provided with at least one additional group of flux barriers arranged farther toward the outer circumference of the rotor core than the flux barriers.

8. The rotary electric machine rotor as recited in claim 7, wherein
each of the flux barriers of the additional group of flux barriers are configured without any of the bridges.

9. The rotary electric machine rotor as recited in claim 1, wherein
the flux barriers being arranged at intervals of a fixed mechanical angle.

10. The rotary electric machine rotor as recited in claim 1, wherein
the flux barriers protrude toward the rotor shaft as viewed in a cross sectional plane that is perpendicular to an axis of rotation of the rotor shaft.

11. The rotary electric machine rotor as recited in claim 1, wherein
the flux barriers protrude away the rotor shaft as viewed in a cross sectional plane that is perpendicular to an axis of rotation of the rotor shaft.

12. The rotary electric machine rotor as recited in claim 2, wherein
the bridge is formed along a q-axis that is electrically orthogonal to a d-axis coinciding with a magnetic pole center axis of one of the permanent magnets as viewed in the cross sectional a plane.

13. The rotary electric machine rotor as recited in claim 2, wherein
two of the bridges are formed in at least one of the flux barriers so as to be symmetrically spaced on opposite sides of a q-axis that is electrically orthogonal to a d-axis coinciding with a magnetic pole center axis of one of the permanent magnets as viewed in the cross sectional plane.

14. The rotary electric machine rotor as recited in claim 13, wherein
each of the bridges is formed adjacent to a respective one of the permanent magnets; and
a distance between one of the flux barriers and a respective one of the permanent magnets is inversely proportional to a degree to which the bridges of that one of the flux barriers become magnetically saturated by a magnetic flux provided by the permanent magnets adjacent to the bridges of that one of the flux barriers.

15. The rotary electric machine rotor as recited in claim 14, wherein
the bridges are configured to approach the outer circumference of the rotor core as they extend away from their respective permanent magnets.

16. The rotary electric machine rotor as recited in claim 15, wherein
the rotor core is further provided with at least one additional group of flux barriers arranged farther toward the outer circumference of the rotor core than the flux barriers.

17. The rotary electric machine rotor as recited in claim 16, wherein
each of the flux barriers of the additional group of flux barriers are configured without any of the bridges.

18. The rotary electric machine rotor as recited in claim 2, wherein
the rotor core is further provided with at least one additional group of flux barriers arranged farther toward the outer circumference of the rotor core than the flux barriers.

19. The rotary electric machine rotor as recited in claim 18, wherein
each of the flux barriers of the additional group of flux barriers are configured without any of the bridges.
